(19) United States
(12) Patent Application Publication
(10) Pub. No.: US 2026/0007092 A1
(43) Pub. Date: Jan. 8, 2026

(54) SYSTEM AND METHOD FOR CONTROLLING THE OPERATION OF A SEED-PLANTING IMPLEMENT

(71) Applicants: CNH Industrial America LLC, New Holland, PA (US); Global Neighbor, Inc., Dayton, OH (US)

(72) Inventors: Michael Christopher Conboy, Chicago, IL (US); Chad M. Johnson, Arlington Heights, IL (US); Darian Eugene Landolt, Evanston, IL (US); Christopher Hoffman, Dayton, OH (US); Jonathan Jackson, Dayton, OH (US); Loran Steinlage, West Union, IA (US); Patrick Jackson, Xenia, OH (US)

(21) Appl. No.: 19/257,764

(22) Filed: Jul. 2, 2025

Related U.S. Application Data
(60) Provisional application No. 63/667,239, filed on Jul. 3, 2024.

(51) Int. Cl. A01C 7/10; A01C 1/00; A01C 7/04

(52) U.S. Cl. CPC A01C 7/105; A01C 1/00; A01C 7/042

(57) ABSTRACT

A system for controlling the operation of a seed-planting implement includes a row unit frame and a plurality of ground-engaging tools supported by the frame. Additionally, a seed reservoir is supported by the frame and configured to store seeds therein. Furthermore, the system includes a metering component configured to meter untreated seeds and a seed treatment assembly configured to receive and treat the untreated seeds metered by the metering component and convey treated seeds to the seed reservoir. Moreover, the system includes a fill level sensor configured to generate data indicative of a fill level of the seed reservoir and a computing system communicatively coupled to the fill level sensor. The computing system is configured to determine the fill level of the seed reservoir based on the data generated by the fill level sensor and control an operation of the metering component based on the determined fill level.

### CROSS-REFERENCE TO RELATED APPLICATIONS

The present application is based upon and claims the right of priority to U.S. Patent Application No. 63/667,239, filed Jul. 3, 2024, the disclosure of which is hereby incorporated by reference herein in its entirety for all purposes.

### FIELD OF THE INVENTION

The present disclosure generally relates to seed-planting implements and, more particularly, to systems and methods for controlling the operation of a seed-planting implement.

### BACKGROUND OF THE INVENTION

Modern farming practices strive to increase yields of agricultural fields. In this respect, seed-planting implements are towed behind a tractor or other work vehicle to disperse seed throughout a field. Sometimes, prior to dispersing the seeds through the field with a seed-planting implement, the seeds are treated at an off-site location away from the seed-planting implement prior to loading the seed into the seed-planting implement to increase the potential for larger crop yields. For example, the seeds may be primed for enhancing seed germination, seed stress tolerance, and/or the like. However, certain seed treatment techniques result in undesirable crop yields, particularly in changing climate and/or environmental conditions, and/or are too expensive to implement. As such, systems and methods have been developed to treat seeds at an off-site location away from the seed-planting implement prior to loading the seed into the seed-planting implement. While such systems and methods work well, further improvements are needed.

Accordingly, an improved system and method for controlling the operation of a seed-planting implement would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to a seed-planting implement. The seed-planting implement includes a tool bar and a plurality of row units supported on the tool bar. Each row unit includes a row unit frame and a plurality of ground-engaging tools supported by the row unit frame. The plurality of ground-engaging tools are configured to engage the soil during a seed planting operation. Additionally, each row unit includes a seed reservoir supported by the row unit frame and configured to store seeds therein. Furthermore, each row unit includes a metering component configured to meter unprimed seeds. Moreover, each row unit includes a seed priming assembly configured to receive and prime the unprimed seeds metered by the metering component and convey primed seeds to the seed reservoir for planting.

In another aspect, the present subject matter is directed to a system for controlling the operation of a seed-planting implement. The system includes a row unit frame and a plurality of ground-engaging tools supported by the row unit frame. The plurality of ground-engaging tools are configured to engage the soil during a seed planting operation. Furthermore, the system includes a seed reservoir supported by the row unit frame and configured to store seeds therein. Moreover, the system includes a metering component configured to meter untreated seeds and a seed treatment assembly configured to receive and treat the untreated seeds metered by the metering component and convey the treated seeds to the seed reservoir. Additionally, the system includes a fill level sensor configured to generate data indicative of a fill level of the seed reservoir and a computing system communicatively coupled to the fill level sensor. The computing system is configured to determine the fill level of the seed reservoir based on the data generated by the fill level sensor and control an operation of the metering component based on the determined fill level of the seed reservoir.

In a further aspect, the present subject matter is directed to a system for controlling the operation of a seed-planting implement. The system includes a row unit frame and a plurality of ground-engaging tools supported by the row unit frame. The plurality of ground-engaging tools are configured to engage the soil during a seed planting operation. Moreover, the system includes a metering component configured to meter untreated seeds and a seed treatment assembly configured to receive and treat the untreated seeds metered by the metering component. Additionally, the system includes a seed rate sensor configured to generate data indicative of a rate at which the untreated seeds are metered to the seed treatment assembly and a computing system communicatively coupled to the seed rate sensor. The computing system is configured to determine the rate at which the untreated seeds are metered to the seed treatment assembly based on the data generated by the seed rate sensor and control an operation of the metering component based on the determined rate at which the untreated seeds are metered to the seed treatment assembly.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of one embodiment of a seed-planting implement in accordance with aspects of the present subject matter;

FIG. 2 illustrates a side view of one embodiment of a row unit of a seed-planting implement in accordance with aspects of the present subject matter;

FIG. 3 illustrates a perspective view of a portion of a row unit having a seed priming assembly mounted to a row unit frame of the row unit;

FIG. 4 illustrates a perspective view of the seed priming assembly shown in FIG. 3;

FIG. 5 illustrates an alternative perspective view of the seed priming assembly shown in FIG. 3;

FIG. 6 illustrates a top view of the seed priming assembly shown in FIG. 3 with a cover of the seed priming assembly removed;

FIG. 7 illustrates a perspective view of one embodiment of a seed priming unit of the seed priming assembly shown in FIG. 3;

FIG. 8 illustrates a bottom view of the seed priming unit shown in FIG. 7;

FIG. 9 illustrates a schematic view of one embodiment of a system for controlling the operation of a seed-planting implement in accordance with aspects of the present subject matter;

FIG. 10 illustrates a flow diagram providing one embodiment of example control logic for controlling the operation of a seed-planting implement in accordance with aspects of the present subject matter;

FIG. 11 illustrates a flow diagram providing one embodiment of example control logic for controlling the operation of a seed-planting implement in accordance with aspects of the present subject matter; and

FIG. 12 illustrates a flow diagram of one embodiment of a method for controlling the operation of a seed-planting implement in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems and methods for controlling the operation of a seed-planting implement. As will be described below, the seed-planting implement may include a tool bar and a plurality of row units supported on the tool bar. Each row unit may include a row unit frame and a plurality of ground-engaging tools supported by the row unit frame for engaging the soil during a seed planting operation. Moreover, each row unit may include a seed treatment assembly, such as a seed priming assembly, configured to receive and treat untreated seeds convey the treated seeds to one or more seed reservoirs configured to store seeds therein. Furthermore, each row unit may include a metering component configured to meter untreated seeds to the seed treatment assembly. Additionally, each row unit may include the seed reservoir(s). For example, each row unit may include a primary seed hopper for storing treated (e.g., primed) seed therein, a secondary seed hopper for storing untreated (e.g., unprimed) seed therein, and/or a seed container of the seed treatment assembly within which the unprimed seed is primed.

In several embodiments, a computing system may be configured to control the operation of the metering component based on a determined fill level of the seed reservoir(s). More specifically, as the seed reservoir(s) is filled with seeds treated by the seed treatment assembly, the computing system may determine the fill level of the seed reservoir(s) based on data received from one or more fill level sensors. In some embodiments, the computing system may compare the determined fill level of the seed reservoir(s) to a predetermined fill level threshold range. Thereafter, the computing system may control the operation of the metering component to meter the untreated seeds to the seed treatment assembly based on the determined fill level of the seed reservoir(s) relative to the predetermined fill level threshold range.

Additionally, or alternatively, in some embodiments, the computing system may be configured to control the operation of the metering component based on a determined rate at which untreated seed is metered to the seed treatment assembly. More specifically, as the untreated seeds are metered to the seed treatment assembly by the metering component, the computing system may determine the rate at which the untreated seeds are metered to the seed treatment assembly based on data received from one or more seed rate sensors. In some embodiments, the computing system may compare the determined rate to a predetermined seed rate threshold range. Thereafter, the computing system may control the operation of the metering component to meter the untreated seeds to the seed treatment assembly based on the determined rate relative to the predetermined seed rate threshold range.

Utilizing seed treatment assemblies, such as seed priming assemblies, on row units of seed-planting implements and controlling the metering of seeds to the seed treatment assemblies based on determined fill levels of the seed reservoirs and/or determined rates of untreated seeds to seed treatment assemblies may improve crop yields. More specifically, using seed treatment assemblies on each row unit for treating seeds may act as a catalyst for moving the seed from a dormant stage just prior to planting. Such seed treatment just prior to planting may enhance seed germination, seed stress tolerance, and/or the like and, thus may improve crop yields. Additionally, controlling the metering of seeds to the seed treatment assemblies based on determined fill levels of the seed reservoirs and/or the rate at which the seeds are metered to the seed treatment assemblies inhibit or prevent overpacking or overflowing of seed reservoirs and/or allow for control of seed treatment, such as the amount of seed treatment applied to the seeds, by the seed treatment assembly.

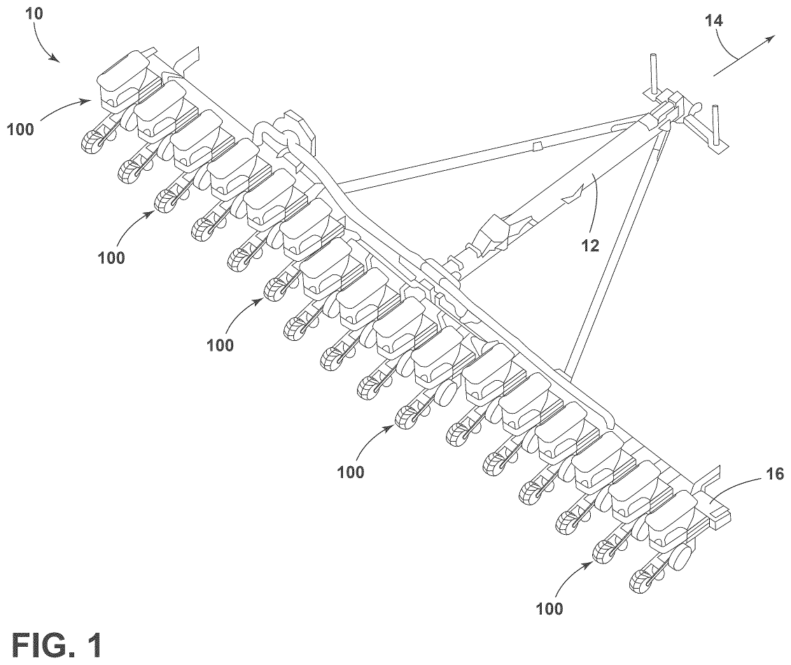

Referring now to the drawings, FIG. 1 illustrates a perspective view of one embodiment of a seed-planting implement 10 in accordance with aspects of the present subject matter. In the illustrated embodiment, the seed-planting implement 10 is configured as a planter. However, in alternative embodiments, the seed-planting implement 10 may generally correspond to any suitable seed-planting equipment or implement, such as a seeder or another seed-dispensing implement.

As shown in FIG. 1, the seed-planting implement 10 includes a tow bar 12. In general, the tow bar 12 is configured to couple to a tractor or other agricultural vehicle (not shown), such as via a suitable hitch assembly (not shown). In this respect, the tractor may tow the seed-planting implement 10 across a field in a direction of travel (indicated by arrow 14) to perform a seed-planting operation on the field.

Furthermore, the seed-planting implement 10 includes a toolbar 16 coupled to the aft end of the tow bar 12. More specifically, the toolbar 16 is configured to support and/or couple to one or more components of the seed-planting implement 10. For example, the toolbar 16 is configured to support one or more seed-planting units or row units 100. As will be described below, each row unit 100 is configured to form a furrow having a selected depth within the soil of the field. Thereafter, each row unit 100 deposits seeds within the corresponding furrow and subsequently closes the corresponding furrow after the seeds have been deposited, thereby establishing rows of planted seeds. In some embodiments, the bulk of the seeds to be planted may be stored in one or more bulk storage containers or central hoppers (not shown) supported on the toolbar 16 and/or the tow bar 12. Thus, as seeds are planted by the row units 100, a pneumatic distribution system (not shown) may distribute seeds from the central hopper(s) to the individual row units 100.

In general, the seed-planting implement 10 may include any number of row units 100. For example, in the illustrated embodiment, the seed-planting implement 10 includes sixteen row units 100 coupled to the toolbar 16. However, in other embodiments, the seed-planting implement 10 may include six, eight, twelve, twenty-four, thirty-two, or thirty-six row units 100. In addition, the lateral spacing between row units 100 may be selected based on the type of crop being planted. For example, the row units 100 may be spaced approximately thirty inches from one another for planting corn and approximately fifteen inches from one another for planting soybeans.

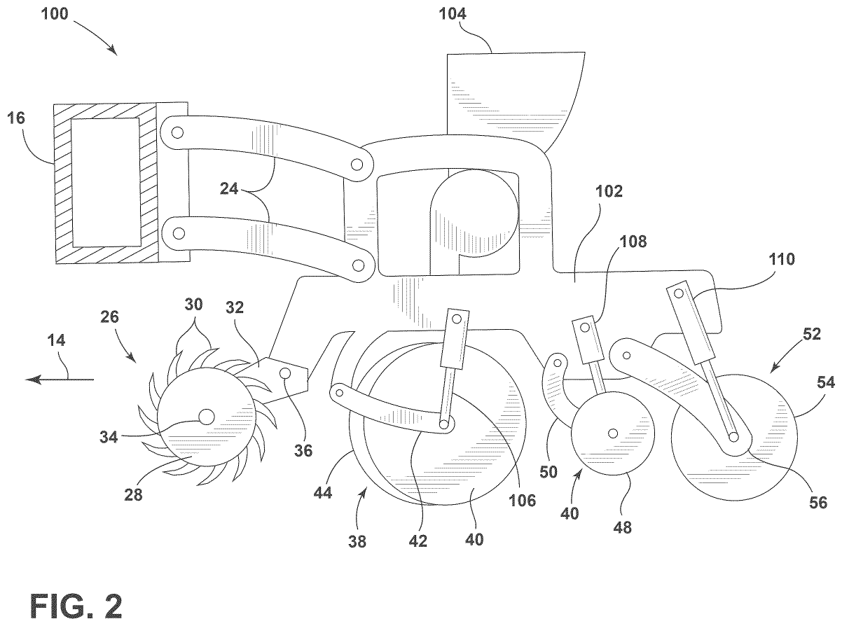

Referring now to FIG. 2, a side view of one embodiment of a row unit 100 is illustrated in accordance with aspects of the present subject matter. As shown, the row unit 100 may include a row unit frame 102 adjustably coupled to the toolbar 16 by links 24. For example, one end of each link 24 may be pivotably coupled to the row unit frame 102, while an opposed end of each link 24 may be pivotably coupled to the toolbar 16. However, in alternative embodiments, the row unit 100 may be coupled to the toolbar 16 in any other suitable manner. Furthermore, one or more seed reservoirs 101, such as a primary seed hopper 104, may be coupled to or otherwise supported on the row unit frame 102 and configured to store seeds (e.g., that are received from a bulk storage containers or filled individually).

Additionally, the row unit 100 includes one or more ground-engaging tools configured to prepare and/or finish the soil during a seed planting operation. For example, as shown in FIG. 2, the row unit 100 includes a residue removal device 26 pivotably coupled to the row unit frame 102 at its forward end relative to the direction of travel 14. In general, the residue removal device 26 may be configured to break up and/or sweep away or otherwise remove residue, dirt clods, and/or the like from the path of the row unit 100. As such, in several embodiments, the residue removal device 26 may include a pair of wheels 28 (one is shown), with each wheel 28 having a plurality of tillage points or fingers 30. As such, the wheels 28 may be configured to roll relative to the soil as the seed-planting implement 10 travels across the field such that the fingers 30 break up and/or sweep away residue and dirt clods. Additionally, the residue removal device 26 may include a support arm 32 that adjustably couples the wheels 28 to the row unit frame 102. For example, one end of the support arm 32 may be pivotably coupled to the wheels 28 via an axle 34, while an opposed end of the support arm 32 may be pivotably coupled to the row unit frame 102 via a pivot joint 36. However, in alternative embodiments, the residue removal device 26 may have any other suitable configuration. For example, in one embodiment, the residue removal device 26 may include only a single wheel 28.

Furthermore, the ground-engaging tool(s) of the row unit 100 may include one or more downstream tools positioned aft of the residue removal device 26 relative to the direction of travel 14. As such, the downstream tool(s) may be configured to interact with soil at a location(s) aft of the residue removal device 26. In this respect, and as will be described below, the downstream tool(s) may facilitate the formation and subsequent closing of a furrow or trench within the soil into which seeds are deposited.

In several embodiments, the downstream tool(s) may include an opening assembly 38 supported on the row unit frame 102. In general, the opening assembly 38 may be configured to form the furrow or trench within the soil. More specifically, in some embodiments, the opening assembly 38 may include a gauge wheel 40 adjustably coupled to the row unit frame 102 via a support arm 42. Furthermore, the opening assembly 38 may also include one or more opener disks 44 configured to excavate a furrow or trench within the soil. Thus, as the seed-planting implement 10 travels across the field, the gauge wheel 40 may be configured to engage the top surface of the soil. In this respect, the position of the gauge wheel 40 relative to the row unit frame 102 may set the penetration of the opener disk(s) 44 (and, thus, the depth of the furrow being excavated).

Moreover, in several embodiments, the downstream tool(s) may include a closing assembly 46 supported on the row unit frame 102. In general, the closing assembly 46 may be configured to close the furrow or trench within the soil by the opening assembly 38. Specifically, in some embodiments, the closing assembly 46 may include a pair of closing disks 48 (one is shown) adjustably coupled to the row unit frame 102 via a support arm 50. In this respect, the closing disks 48 may be positioned relative to each other such that soil flows between the disks 48 as the seed-planting implement 10 travels across the field. As such, the closing disks 48 may be configured to collapse or otherwise close the furrow after seeds have been deposited therein, such as by pushing the excavated soil into the furrow. However, in alternative embodiments, the closing assembly 46 may have any other suitable configuration. For example, in one embodiment, the closing assembly 46 may have closing wheels (not shown) in lieu of the closing disks 48.

Furthermore, in several embodiments, the downstream tool(s) may include a press wheel assembly 52 supported on the row unit frame 102. Specifically, in some embodiments, the press wheel assembly 52 may include a press wheel 54 adjustably coupled to the row unit frame 102 via a support arm 56. In this respect, as the seed-planting implement 10 travels across the field, the press wheel 54 may roll over the closed furrow to firm the soil over the seed and promote favorable seed-to-soil contact. However, in alternative embodiments, the press wheel assembly 52 may have any other suitable configuration.

Additionally, in alternative embodiments, the row unit 100 may include any other suitable downstream tools in addition to or in lieu of the opening assembly 38, the closing assembly 46, and the press wheel assembly 52. Moreover, in some embodiments, the row unit 100 may include only the opening assembly 38 and the closing assembly 46.

As shown, the row unit 100 may include one or more actuators configured to adjust one or more operating parameters of the downstream tool(s). For example, the actuator(s) may be configured to adjust the position of the downstream tool(s) relative to the row unit frame 102 and/or the force being applied to the downstream tool(s). As such, the actuator(s) may correspond to any suitable type of actuator(s), such as a fluid-driven actuator(s) (e.g., a pneumatic cylinder(s)).

In the illustrated embodiment, the row unit 100 includes an opening assembly actuator 106, a closing assembly actuator 108, and a press wheel assembly actuator 110. In this respect, the opening assembly actuator 106 may be configured to adjust one or more operating parameters of the gauge wheel 40, such as the force being applied to the gauge wheel 40 and/or the position of the gauge wheel 40 relative to the row unit frame 102 (which, in turn, adjust the penetration depth of the opener disk(s) 44). Moreover, the closing assembly actuator 108 may be configured to adjust one or more operating parameters of the closing disks 48, such as the force being applied to and/or the position relative to the row unit frame 102 (which may, in turn, adjust the penetration depth) of the closing disks 48. Additionally, the press wheel assembly actuator 110 may be configured to adjust one or more operating parameters of the press wheel 54, such as the force being applied to the press wheel 54. However, in alternative embodiments, the row unit 100 may include any other suitable actuator(s) and/or the actuator(s) may be configured to adjust any other suitable operating parameters of the downstream tool(s).

The configuration of the seed-planting implement 10 described above and shown in FIGS. 1 and 2 is provided only to place the present subject matter in an exemplary field of use. Thus, the present subject matter may be readily adaptable to any manner of seed-planting implement configuration.

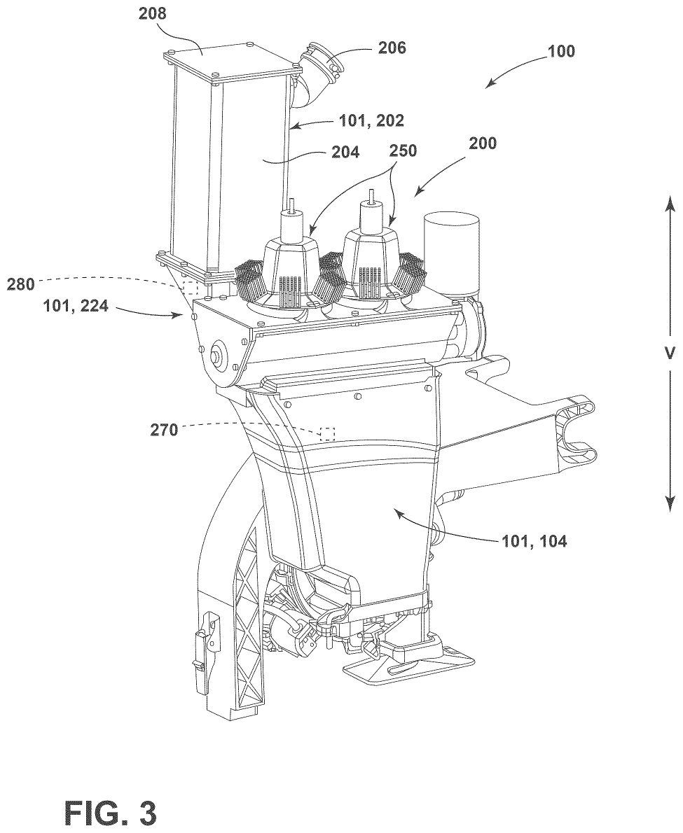

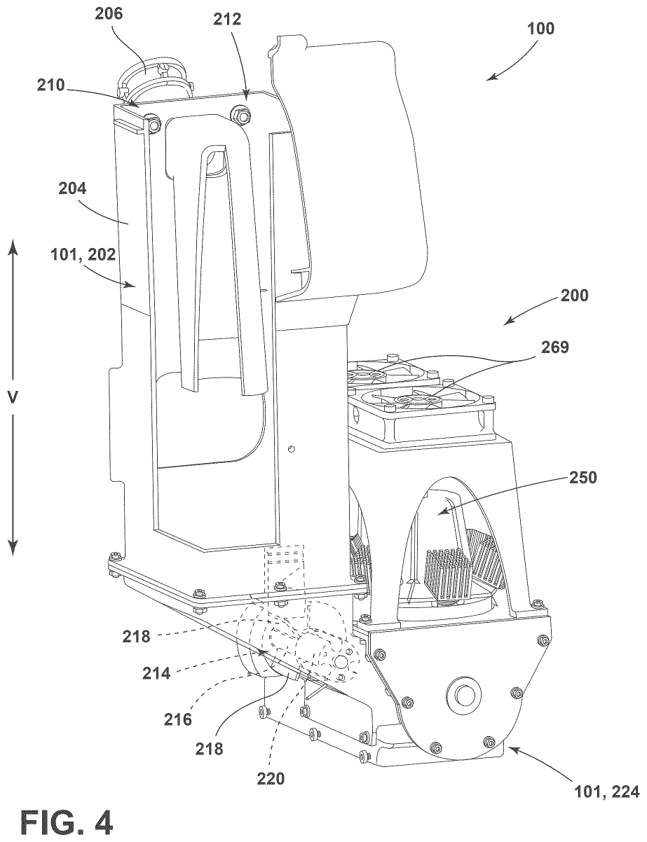

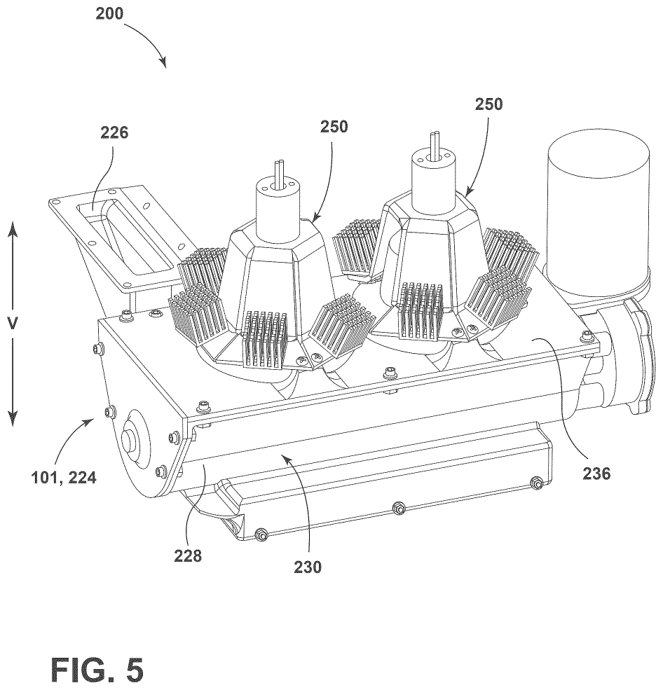

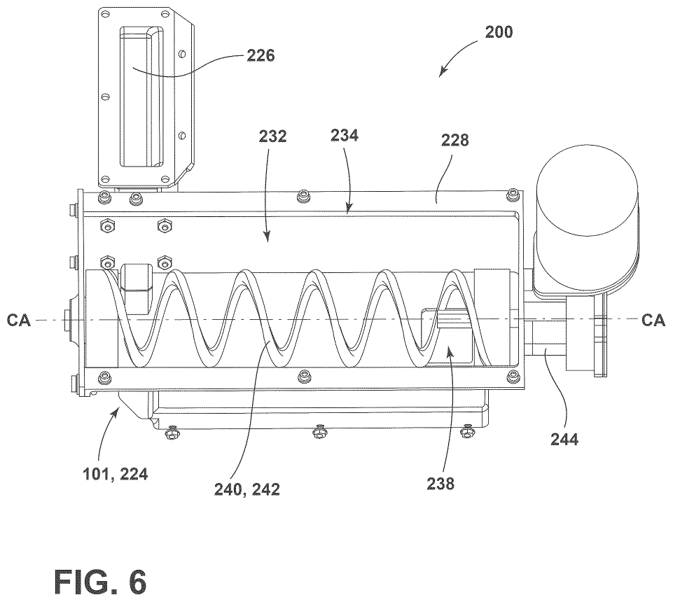

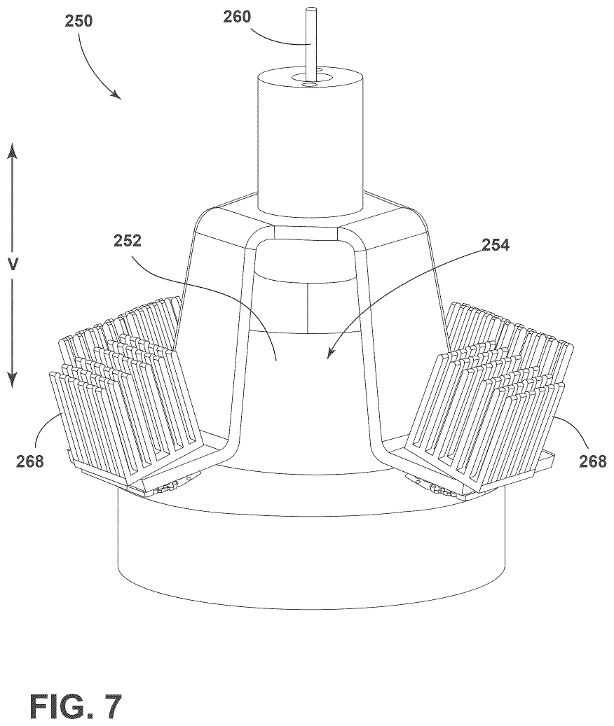

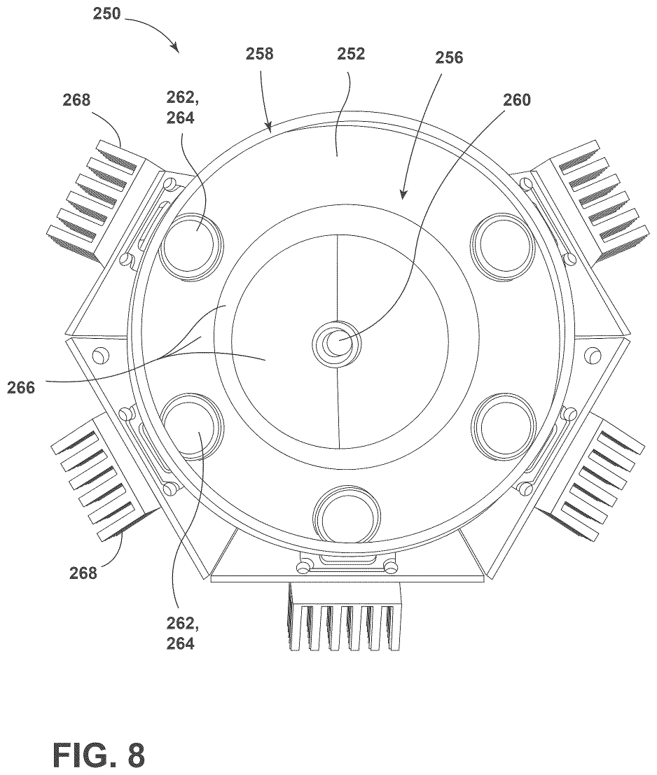

Referring now to FIGS. 3 through 8, differing views of one embodiment of a seed priming assembly 200 for use with a seed-planting implement are shown in accordance with aspects of the present subject matter. Specifically, FIG. 3 illustrates a perspective view of a portion of one of the row units 100 with the seed priming assembly 200 mounted to the row unit frame 102 the row unit 100. Additionally, FIG. 4 illustrates a perspective view of the seed priming assembly 200 with a portion of the seed priming assembly 200 removed for clarity. FIG. 5 illustrates an alternative perspective view of the seed priming assembly 200, particularly illustrating a seed container 224 and a pair of seed priming units 250 mounted to the seed container 224. Furthermore, FIG. 6 illustrates a top view of the seed priming assembly 200 with a cover of the seed container 224 removed. FIG. 7 illustrates a perspective view of one of the seed priming units 250. Moreover, FIG. 8 illustrates a bottom view of the seed priming unit 250.

As shown in FIGS. 3 and 4, each row unit 100 may include one or more seed reservoirs 101, such as a secondary seed hopper 202. The secondary seed hopper 202 may include a secondary seed hopper housing 204 configured to receive and temporarily store unprimed or otherwise untreated seeds therein to be distributed to the seed priming assembly 200 for priming the unprimed seeds. In some embodiments, the secondary seed hopper housing 204 may be connected to the pneumatic distribution system (not shown), for example, via a conduit or hose 206, for receiving the unprimed seeds from the bulk storage containers or central hopper(s) (not shown). Additionally, or alternatively, in some embodiments, the secondary seed hopper housing 204 may be manually filled with the unprimed seeds, such as by manually pouring the unprimed seeds into the secondary seed hopper housing 204 with, for instance, shovel or container. For example, the secondary seed hopper 202 may include a secondary seed hopper cap or lid 208 (FIG. 3) that is removable for exposing a fill inlet 210 (FIG. 4) of the secondary seed hopper housing 204 for manually filling an interior 212 (FIG. 4) of the secondary seed hopper housing 204. The fill inlet 210 may be positioned at the top of the secondary seed hopper housing 204 in vertical direction V so that the secondary seed hopper housing 204 may be filled with minimal seed spilling.

In some embodiments, the secondary seed hopper 202 may be mounted to the seed priming assembly 200. For example, as shown in FIGS. 3 and 4, the secondary seed hopper 202 may be positioned and mounted to the seed priming assembly 200 above the seed priming assembly 200 in vertical direction V. In this respect, gravity may move the unprimed seeds stored within the secondary seed hopper housing 204 toward the seed priming assembly 200. Furthermore, the secondary seed hopper housing 204 may include an outlet (not shown) corresponding to an opening through which the unprimed seeds exit the secondary seed hopper 202. However, it should be appreciated that, in some embodiments, each row unit 100 may not include a secondary seed hopper and the unprimed seeds may be directly moved to the seed priming assembly 200 from the bulk storage containers or central hoppers and/or be manually moved into the seed priming assembly 200 by a user, such as by manually pouring seeds from a bucket or other container.

Additionally, each row unit 100 includes the seed priming assembly 200. The seed priming assembly 200 may be configured to receive unprimed seeds, such as the metered unprimed seeds from the secondary seed hopper 202, and convert or prime the unprimed seeds into primed seeds for planting by the seed-planting implement 10. As such, the seed priming assembly 200 may include one of the seed reservoirs 101, which is configured as a seed container 224 within which the unprimed seeds are primed. The seed container 224 may include a seed container inlet or chute 226 (FIGS. 5, 6), which, in some embodiments, may be mounted to the secondary seed hopper housing 204 and positioned below the outlet of the secondary seed hopper housing 204 for receiving the unprimed seeds from the secondary seed hopper 202 as they exit the secondary seed hopper 202. However, it should be appreciated that the seed priming assembly 200 may also, or alternatively, be manually filled with unprimed seeds by pouring the unprimed seeds into the seed container chute 226 with, for instance, a shovel or bucket.

Moreover, an agitator or metering component 214 may be positioned within the seed container chute 226 or otherwise upstream/prior to the seed container 224 for spacing apart or metering the unprimed seeds prior to or as they move into the seed container chute 226 of the seed priming assembly 200. As shown in FIG. 4, the metering component 214 may include a shaft 216. A plurality of vanes or fins 218 may protrude from the shaft 216 for agitating or metering the unprimed seeds as they move into the seed container chute 226 of the seed priming assembly 200. In this respect, the shaft 216 may be rotatable by a metering component motor 220, such as an alternating current (AC) motor. As the metering component motor 220 rotates the shaft 216, the fins 218 rotate with the shaft 216 and meter the unprimed seeds. As will be described below, a computing system may be communicatively coupled to the metering component 214, such as to the metering component motor 220, for controlling the operation of the metering component 214. In some embodiments, the metering component motor 220 may be configured as a variable speed motor. As such, the rotational speed of the metering component motor 220 may be adjustable by the computing system.

Furthermore, the seed container 224 includes a container vessel 228 defining a vessel exterior 230 (FIG. 5) and a vessel interior 232 (FIG. 6). The seed container chute 226 may be connected to the container vessel 228 and direct the unprimed seeds into the vessel interior 232. Moreover, the container vessel 228 may define an interior access opening 234 (FIG. 6) defined through the container vessel 228. The interior access opening 234 may be covered by a removable vessel cap or lid 236 (FIG. 5) for providing selective access to the vessel interior 232. The interior access opening 234 and the vessel lid 236 may be positioned on top of the container vessel 228. Additionally, a seed container outlet 238 (FIG. 6), such as an outlet opening defined through the container vessel 228, may be positioned at the bottom of the container vessel 228 so that the primed seeds exit/are released from the seed priming assembly 200. As will be described below, in some embodiments, the container vessel 228 may be mounted to the primary seed hopper 104 so that the primed seeds exiting the seed priming assembly 200 may enter the primary seed hopper 104 for final storage before being planted/dispersed over the field.

Moreover, the seed priming assembly 200 may include a seed mover 240. The seed mover 240 may be a feature of the seed priming assembly 200 for continuously moving/conveying the unprimed seeds through the container vessel 228. The seed mover 240 may continuously convey the unprimed seeds that enter the container vessel 228 from the seed container chute 226 to the seed container outlet 238 while the unprimed seeds are primed within the container vessel 228 by one or more seed priming units 250 that will be described below. In this respect, by continuously conveying the unprimed seeds through the container vessel 228, the seed mover 240 may ensure that the unprimed seeds are not over primed/primed too much by the seed priming unit(s) 250. For example, as shown in FIG. 6, the seed mover 240 may be configured as a rotatable coil or auger 242 that is continuously rotatable about a central axis CA by an auger motor 244 (e.g., AC motor) mounted to the container vessel 228. In this respect, the rotatable auger 242 may not stop rotating while the auger motor 244 is activated. The auger motor 244 and, thus, the rotatable auger 242, may rotate at an unchanging or constant speed so that the unprimed seeds are primed by the seed priming unit(s) 250 without over priming the unprimed seeds. Furthermore, the rotatable auger 242 turns over or tumbles the unprimed seeds as they are conveyed through the container vessel 228 so that each of the unprimed seeds are uniformly primed (e.g., on all sides) by the seed priming unit(s) 250. Additionally, the rotatable auger 242 may extend along a container vessel length CVL from the seed container chute 226 to the seed container outlet 238. As such, as the rotatable auger 242 is continuously rotated, the unprimed seeds are moved by the rotatable auger 242 along the container vessel length CVL of the container vessel 228 from the seed container chute 226 to the seed container outlet 238. Additionally, in some embodiments, the rotatable auger 242 may extend over the seed container outlet 238 so that gravity may pull the newly primed seeds out of the container vessel 228 and, for example, into the primary seed hopper 104.

It should be appreciated that, while the seed mover 240 is configured as a rotatable auger 242 in the example shown in the figures and described herein, the seed mover 240 may be configured as any suitable type of seed mover for conveying the seeds through the container vessel 228. For example, the seed mover 240 may be configured as a belt-on-roller conveyor, a pneumatic pressure system, and/or the like.

Additionally, the seed priming assembly 200 may include one or more seed priming units 250 (FIGS. 5, 7, 8). For example, as shown in FIG. 5, the seed priming assembly 200 may include a pair of seed priming units 250 linearly arranged along container vessel length CVL and mounted on the vessel lid 236 of the container vessel 228. Each seed priming unit 250 may include a priming unit frame or base 252 including a base exterior 254 (FIG. 7) and a base interior 256 (FIG. 8) exposed through a base opening 258 (FIG. 8). The base opening 258 of each seed priming unit 250 may be positioned over a priming unit opening (not shown) defined through the vessel lid 236 and, thus, exposing the vessel interior 232 of the container vessel 228 to the base interior 256.

Moreover, each seed priming unit 250 may be configured to emit and direct at least one type of energy wave through the priming unit opening at the unprimed seeds for priming the unprimed seeds while they are conveyed by the rotatable auger 242 through the container vessel 228. For example, in some embodiments, each seed priming unit 250 may include a heating element 260 (FIGS. 7, 8) positioned at least partially within the base interior 256. The heating element 260 may be electrically powered and configured to convert electrical power into heat waves. The heating element 260 may be angled or directed downward so that the heat waves may be directed downward through the base opening 258 and into the vessel interior 232 of the container vessel 228 to prime the unprimed seeds.

Additionally, or alternatively, in some embodiments, each seed priming unit 250 may include one or more light sources 262 (FIG. 8) positioned within the base interior 256 and configured to emit light waves. The light sources 262 may be angled or directed downward so that the light waves may be directed downward through the base opening 258 and into the vessel interior 232 of the container vessel 228 to prime the unprimed seeds. For example, the seed priming unit 250 may include a plurality of light emitting diodes (LEDs) 264. As shown in FIG. 8, the plurality of LEDs 264 may be circumferentially arranged/spaced apart along the base interior 256 so that the light waves may be directed at the unprimed seeds as the unprimed seeds are conveyed through the container vessel 228 by the rotatable auger 242. In this respect, the unprimed seeds are primed with the light waves as they travel through the container vessel 228.

It should be appreciated that, while the seed priming units 250 include heating elements 258 and LEDs 264 in the example shown in the figures and described herein, each seed priming unit 250 may include any other suitable type of device or mechanism for emitting any other suitable type of energy wave. For example, each seed priming unit 250 may include one or more lasers, ultrasound devices, microwave devices, and/or the like.

Additionally, or alternatively, in some embodiments, the base interior 256 may include a reflective surface 266 (FIG. 8). In this respect, the base interior 256 may be configured to reflect energy waves (e.g., heat waves, light waves) at the unprimed seeds within the container vessel 228. For example, the base interior 256 may include a thermal insulator with an aluminum surface. However, it should be appreciated that the base interior 256 may include any other suitable reflective surface.

Moreover, the seed priming assembly 200 may include one or more cooling devices or mechanisms for dissipating heat from or otherwise cooling the seed priming units 250. For example, in some embodiments, each seed priming unit 250 may include one or more heat sinks or heat fins 268 (FIGS. 7, 8) protruding from the priming unit base 252 for dissipating heat produced by the seed priming unit 250. Additionally, or alternatively, in some embodiments, a plurality of fans 269 (FIG. 4) may be mounted or positioned above the seed priming units 250 for projecting a flow of cool air onto the seed priming units 250.

Furthermore, in some embodiments, the primary seed hopper 104 (FIG. 3) of each row unit 100 may be positioned below and mounted to the container vessel 228 of the seed container 224. The primary seed hopper 104 may include a primary seed hopper lid (not shown) including an inlet (not shown) for receiving the primed seed falling through the seed container outlet 238 within an interior (not shown) of the primary seed hopper 104. The primed seeds may be stored within the primary seed hopper 104 until planting.

Additionally, in some embodiments, one or more fill level sensors 270 may be positioned on and/or within one or more of the seed reservoirs 101 of each row unit 100, such as the primary seed hopper 104 or the seed container 224. In general, the fill level sensor(s) 270 is configured to generate data indicative of a seed fill level of the seed reservoir(s) 101. As will be described below, the data generated by the fill level sensor(s) 270 is, in turn, subsequently used to determine the fill level of the seed reservoir(s) 101.

In general, the fill level sensor(s) 270 may correspond to any suitable sensing device(s) configured to generate data indicative of the seed fill level of the seed reservoir(s) 101. For example, in one embodiment, the fill level sensor(s) 270 may correspond to a contact sensor(s). However, in alternative embodiments, the fill level sensor(s) 270 may correspond to any other suitable sensing device(s), such as a proximity sensor(s), imaging device(s), and/or the like.

Furthermore, any number of fill level sensor(s) 270 may be positioned on and/or within the seed reservoir(s) 101 of each row unit 100 and configured to generate data indicative of the seed fill level of the seed reservoir(s) 101. For example, in the embodiment shown in FIG. 3, a single fill level sensor 270 is positioned within the primary seed hopper 104. However, it should be appreciated that the fill level sensor(s) 270 may be positioned at any other suitable location on or within the primary seed hopper 104 for generating data indicative of the fill level of primary seed hopper 104.

Additionally, or alternatively, in some embodiments, one or more seed rate sensors 280 may be positioned on and/or within one or more of the seed reservoirs 101 of each row unit 100, such as the seed container 224. In general, the seed rate sensor(s) 280 is configured to generate data indicative of a rate at which the untreated seeds are metered to the seed container 224 of the seed priming assembly 200. As will be described below, the data generated by the seed rate sensor(s) 280 is, in turn, subsequently used to determine the seed rate at which the untreated seeds are metered to the seed container 224 of the seed priming assembly 200.

In general, the seed rate sensor(s) 280 may correspond to any suitable sensing device(s) configured to generate data indicative of the seed rate at which the untreated seeds are metered to the seed container 224 of the seed priming assembly 200. For example, in one embodiment, the seed rate sensor(s) 280 may correspond to an imaging device(s). However, in alternative embodiments, the seed rate sensor(s) 280 may correspond to any other suitable sensing device(s), such as a pressure sensor(s) and/or the like.

Furthermore, any number of seed rate sensor(s) 280 may be positioned on and/or within the seed container 224 of the seed priming assembly 200 of each row unit 100 and configured to generate data indicative of the seed rate at which the untreated seeds are metered to the seed container 224. For example, in the embodiment shown in FIG. 3, a single seed rate sensor 280 is positioned within the seed container chute 226 of the seed container 224. However, it should be appreciated that the seed rate sensor(s) 280 may be positioned at any other suitable location on or within the seed container 224 for generating data indicative of the seed rate at which the untreated seeds are metered to the seed container 224.

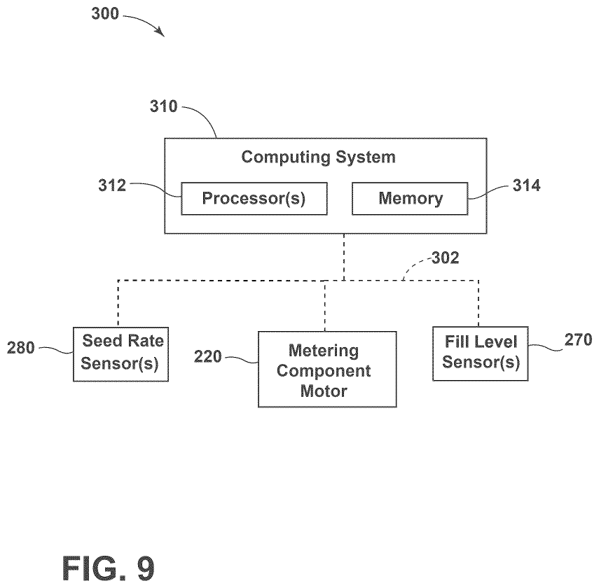

Referring now to FIG. 9, a schematic view of one embodiment of a system 300 for controlling the operation of a seed-planting implement is illustrated in accordance with aspects of the present subject matter. In general, the system 300 will be described herein with reference to the seed-planting implement 10 described above with reference to FIGS. 1-8. However, it should be appreciated by those of ordinary skill in the art that the disclosed system 300 may generally be utilized with seed-planting implements having any other suitable seed-planting implement configuration.

As shown in FIG. 9, the system 300 generally includes one or more components of the seed-planting implement 10. For example, in the illustrated embodiment, the system 300 includes the fill level sensor(s) 270, the seed rate sensor(s) 280, and/or the metering component motor 220 of the seed-planting implement 10.

In accordance with aspects of the present subject matter, the system 300 may include a computing system 310 communicatively coupled to one or more components of the seed-planting implement 10 and/or the system 300 to allow the operation of such components to be electronically or automatically controlled by the computing system 310. For instance, the computing system 310 may be communicatively coupled to the fill level sensor(s) 270 via a communicative link 302. As such, the computing system 310 may be configured to receive data from the fill level sensor(s) 270 that is indicative of the fill level of the seed reservoir(s) 101 of each row unit 100 of the seed-planting implement 10. Additionally, the computing system 310 may be communicatively coupled to the seed rate sensor(s) 280 via the communicative link 302. As such, the computing system 310 may be configured to receive data from the seed rate sensor(s) 280 that is indicative of the rate at which the untreated seeds are metered to the seed container 224 of the seed priming assembly 200 of each row unit 100 of the seed-planting implement 10. Furthermore, the computing system 310 may be communicatively coupled to the metering component motor 220 of each row unit 100 via the communicative link 302. In this respect, the computing system 310 may be configured to control the operation of the metering component motor 220 in a manner that adjusts the metering rate of the untreated seeds to the seed container 224 of the seed priming assembly 200. Additionally, the computing system 310 may be communicatively coupled to any other suitable components of the seed-planting implement 10 and/or the system 300.

In general, the computing system 310 may comprise any suitable processor-based device known in the art, such as a given controller or computing device or any suitable combination of controllers or computing devices. Thus, in several embodiments, the computing system 310 may include one or more processor(s) 312 and associated memory device(s) 314 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 314 of the computing system 310 may generally comprise memory element(s) including, but not limited to, a computer readable medium (e.g., random access memory (RAM)), a computer readable non-volatile medium (e.g., a flash memory), a floppy disc, a compact disc-read only memory (CD-ROM), a magneto-optical disc (MOD), a digital versatile disc (DVD), and/or other suitable memory elements. Such memory device(s) 314 may generally be configured to store suitable computer-readable instructions that, when implemented by the processor(s) 312, configure the computing system 310 to perform various computer-implemented functions, such as one or more aspects of the methods and algorithms that will be described herein. In addition, the computing system 310 may also include various other suitable components, such as a communications circuit or module, one or more input/output channels, a data/control bus and/or the like.

It should be appreciated that the computing system 310 may correspond to an existing computing system(s) of the seed-planting implement 10 and/or the work vehicle (not shown), itself, or the computing system 310 may correspond to a separate processing device. For instance, in one embodiment, the computing system 310 may form all or part of a separate plug-in module that may be installed in association with the seed-planting implement 10 and/or work vehicle to allow for the disclosed systems to be implemented without requiring additional software to be uploaded onto existing control devices of the seed-planting implement 10 and/or work vehicle.

Furthermore, it should also be appreciated that the functions of the computing system 310 may be performed by a single processor-based device or may be distributed across any number of processor-based devices, in which instance such devices may be considered to form part of the computing system 310. For instance, the functions of the computing system 310 may be distributed across multiple application-specific controllers or computing devices, such as a navigation controller, an engine computing controller, a transmission controller, an implement controller and/or the like.

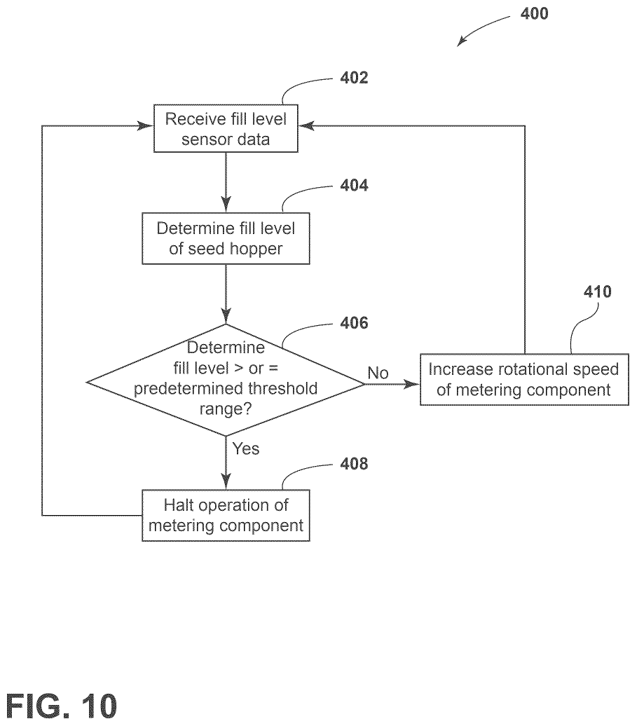

Referring now to FIG. 10, a flow diagram of one embodiment of example control logic 400 that may be executed by the computing system 310 (or any other suitable computing system) for controlling the operation of a seed-planting implement is illustrated in accordance with aspects of the present subject matter. Specifically, the control logic 400 shown in FIG. 10 is representative of steps of one embodiment of an algorithm that can be executed to control the operation of a seed-planting implement in a manner that improves seed priming. Thus, in several embodiments, the control logic 400 may be advantageously utilized in association with a system installed on or forming part of a seed-planting implement to allow for real-time control of the implement without requiring substantial computing resources and/or processing time. However, in other embodiments, the control logic 400 may be used in association with any other suitable system, application, and/or the like for controlling the operation of a seed-planting implement.

As shown in FIG. 10, at (402), the control logic 400 includes receiving fill level sensor data indicative of a fill level of a seed reservoir configured to store seeds therein. Specifically, as mentioned above, in several embodiments, the computing system 310 is communicatively coupled to the fill level sensor(s) 270 via the communicative link 302. In this respect, the computing system 310 may receive data from the fill level sensor(s) 270 indicative of the seed fill level of the seed reservoir(s) 101, such as the primary seed hopper 104.

Additionally, at (404), the control logic 400 includes determining the fill level of the seed reservoir based on the received fill level sensor data. Specifically, in several embodiments, the computing system 310 is configured to determine the fill level of the seed reservoir(s) 101 based on the fill level sensor data received at (402). For example, in one embodiment, the computing system 310 may access a look-up table(s) stored within its memory device(s) 314 that correlates the fill level sensor data received at (402) to fill level value(s).

Furthermore, at (406), the control logic 400 includes comparing the determined fill level of the seed reservoir to a predetermined fill level threshold range. Specifically, in several embodiments, the computing system 310 is configured to compare the fill level of the seed reservoir(s) 101 determined at (404) to the predetermined fill level threshold range. The predetermined fill level threshold range may correspond to a fill level threshold range selected by an operator of the seed-planting implement 10 or selected by the computing system 310.

In some embodiments, when the fill level determined at (404) falls within or exceeds the predetermined fill level threshold range, it is likely that the seed reservoir(s) 101 is close to being full of seed. As such, the operation of the metering component 214 needs to be halted so that the quantity of seed entering the seed reservoir(s) 101 is slowed or halted. For example, in some embodiments, the quantity of unprimed seed entering the seed container 224 (e.g., from the secondary seed hopper 202) is slowed or halted. Halting the operation of the metering component 214 allows most or all the seeds within the container vessel 228 to be emptied from the container vessel 228 (e.g., into the primary seed hopper 104) by the rotatable auger 242. This inhibits or prevents unprimed seed from being over primed and/or overfilling of the primary seed hopper 104. As such, the control logic 400 proceeds to (408).

Additionally, or alternatively, in some embodiments, when the fill level determined at (404) falls below the predetermined fill level threshold range, it is likely that the seed reservoir(s) 101 is close to being empty of seed. As such, the rotational speed of the metering component 214 needs to be increased so that the quantity of unprimed seed entering the seed container 224 (e.g., from the secondary seed hopper 202) is increased. As such, the control logic 400 proceeds to (410).

Moreover, as shown in FIG. 10, at (408), the control logic 400 includes halting the operation of the metering component. Specifically, in several embodiments, the computing system 310 may be configured to halt the operation of the metering component 214, such as by halting the metering component motor 220. Thereafter, the control logic 400 returns to (402).

Furthermore, at (410), the control logic 400 includes increasing the rotational speed of the metering component. Specifically, in several embodiments, the computing system 310 may be configured to increase the rotational speed of the metering component 214, such as by increasing the speed of the metering component motor 220. Thereafter, the control logic 400 returns to (402).

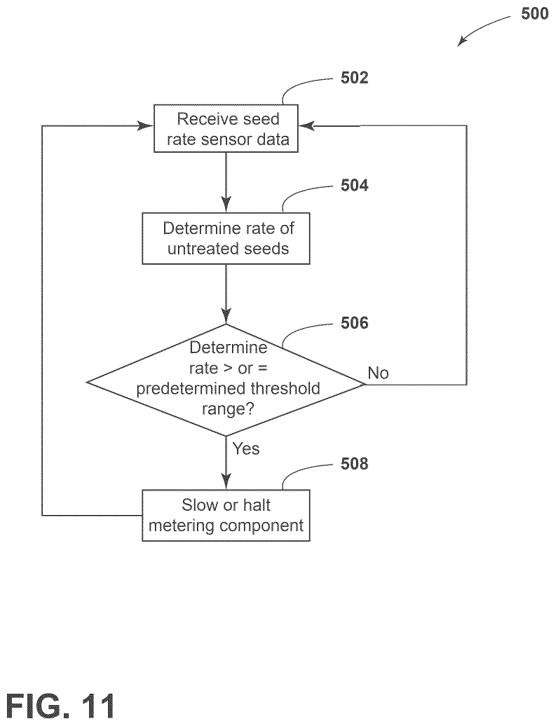

Referring now to FIG. 11, a flow diagram of one embodiment of example control logic 500 that may be executed by the computing system 310 (or any other suitable computing system) for controlling the operation of a seed-planting implement is illustrated in accordance with aspects of the present subject matter. Specifically, the control logic 500 shown in FIG. 11 is representative of steps of one embodiment of an algorithm that can be executed to control the operation of a seed-planting implement in a manner that improves seed priming. Thus, in several embodiments, the control logic 500 may be advantageously utilized in association with a system installed on or forming part of a seed-planting implement to allow for real-time control of the implement without requiring substantial computing resources and/or processing time. However, in other embodiments, the control logic 500 may be used in association with any other suitable system, application, and/or the like for controlling the operation of a seed-planting implement.

As shown in FIG. 11, at (502), the control logic 500 includes receiving seed rate sensor data indicative of a rate at which the untreated seeds are metered to the seed treatment assembly. Specifically, as mentioned above, in several embodiments, the computing system 310 is communicatively coupled to the seed rate sensor(s) 280 via the communicative link 302. In this respect, the computing system 310 may receive data from the seed rate sensor(s) 280 indicative of the rate at which the untreated seeds are metered to the seed container 224 of the seed priming assembly 200.

Additionally, at (504), the control logic 500 includes determining the rate at which the untreated seeds are metered to the seed treatment assembly based on the data generated by the seed rate sensor. Specifically, in several embodiments, the computing system 310 is configured to determine the rate at which the untreated seeds are metered to the seed priming assembly 200 based on the seed rate sensor data received at (502). For example, in one embodiment, the computing system 310 may access a look-up table(s) stored within its memory device(s) 314 that correlates the seed rate sensor data received at (502) to seed rate value(s).

Furthermore, at (506), the control logic 500 includes comparing the determined rate at which the untreated seeds are metered to the seed treatment assembly to a predetermined seed rate threshold range. Specifically, in several embodiments, the computing system 310 is configured to compare the rate at which the untreated seeds are metered to the seed priming assembly 200 determined at (504) to the predetermined seed rate threshold range. The predetermined seed rate threshold range may correspond to a seed rate threshold range selected by an operator of the seed-planting implement 10 or selected by the computing system 310.

In some embodiments, when the rate determined at (504) falls within or exceeds the predetermined fill level threshold range, it is likely that the untreated seed is being metered to the seed container 224 of the seed priming assembly 200 at too fast of a rate for adequate priming of the untreated seed. As such, the operation of the metering component 214 needs to be adjusted so that the rate of the untreated seed being metered to the seed container 224 of the seed priming assembly 200 is slowed or halted. Adjusting the operation of the metering component 214 so that the rate of untreated seed being metered to the seed container 224 is slowed or halted inhibits or prevents too many of the untreated seeds from being simultaneously treated and, thus, negatively affecting seed priming. As such, the control logic 500 proceeds to (508). Otherwise, the control logic 500 returns to (502).

Moreover, as shown in FIG. 11, at (508), the control logic 500 includes slowing or halting the operation of the metering component. Specifically, in several embodiments, the computing system 310 may be configured to slow or halt the operation of the metering component 214, such as by slowing or halting the metering component motor 220. Thereafter, the control logic 500 returns to (502).

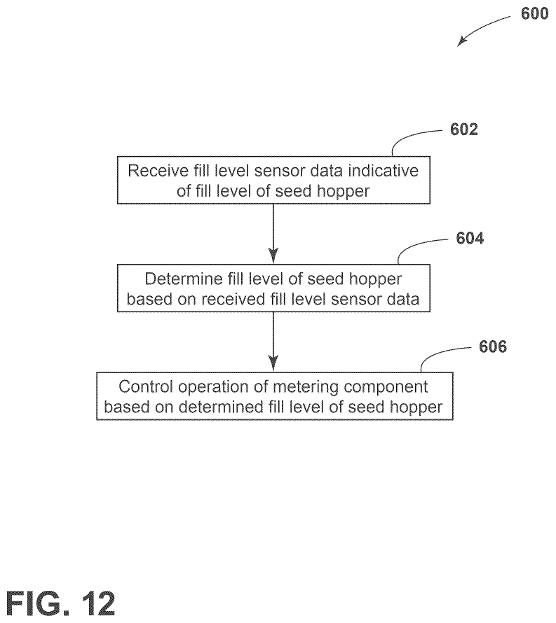

Referring now to FIG. 12, a flow diagram of one embodiment of a method 600 for controlling the operation of a seed-planting implement is illustrated in accordance with aspects of the present subject matter. In general, the method 600 will be described herein with reference to the seed-planting implement 10 and the system 300 described above with reference to FIGS. 1-11. However, it should be appreciated by those of ordinary skill in the art that the disclosed method 600 may generally be implemented with any seed-planting implement having any suitable seed-planting implement configuration and/or within any system having any suitable system configuration. In addition, although FIG. 12 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 12, at (602), the method 600 includes receiving, with a computing system, a fill level sensor data indicative of a fill level of a seed reservoir configured to store seeds therein. For instance, as described above, the computing system 310 may be configured to receive fill level sensor data indicative of the fill level of the seed reservoir(s) 101.

Furthermore, at (604), the method 600 includes determining, with the computing system, the fill level of the seed reservoir based on the received fill level sensor data. For instance, as described above, the computing system 310 may be configured to determine the fill level of the seed reservoir(s) 101 based on the received fill level sensor data.

Moreover, at (606), the method 600 includes controlling, with the computing system, an operation of a metering component configured to meter untreated seeds to a seed treatment assembly for treating the untreated seeds based on the determined fill level of the seed reservoir. For instance, as described above, the computing system 310 may be configured to control the operation of the metering component 214 (e.g., by controlling the operation of the metering component motor 220) based on the determined fill level of the seed reservoir(s) 101.

It is to be understood that the steps of the control logic 400, the control logic 500, and the method 600 are performed by the computing system 310 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the computing system 310 described herein, such as the control logic 400, the control logic 500, and the method 600, is implemented in software code or instructions which are tangibly stored on a tangible computer readable medium. The computing system 310 loads the software code or instructions via a direct interface with the computer readable medium or via a wired and/or wireless network. Upon loading and executing such software code or instructions by the computing system 310, the computing system 310 may perform any of the functionality of the computing system 310 described herein, including any steps of the control logic 400, the control logic 500, and the method 600 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A seed-planting implement, comprising:
a tool bar; and
a plurality of row units supported on the tool bar, each row unit including:
a row unit frame;
a plurality of ground-engaging tools supported by the row unit frame, the plurality of ground-engaging tools configured to engage the soil during a seed planting operation;
a seed reservoir supported by the row unit frame and configured to store seeds therein;
a metering component configured to meter unprimed seeds; and
a seed priming assembly configured to receive and prime the unprimed seeds metered by the metering component and convey primed seeds to the seed reservoir for planting.

2. The seed-planting implement of claim 1, the seed priming assembly comprising:
a seed container coupled to the seed reservoir and including an inlet configured to receive the unprimed seeds metered by the metering component therein and an outlet configured to release the primed seeds therefrom and into the seed reservoir; and
a seed priming unit configured to emit at least one type of energy wave and direct the at least one type of energy wave at the unprimed seeds within the seed container for priming the unprimed seeds.

3. The seed-planting implement of claim 2, the seed priming unit comprising:
a reflective surface configured to reflect the at least one type of energy wave at the unprimed seeds within the seed container.

4. The seed-planting implement of claim 2, wherein:
the seed priming unit includes a heating element configured to emit a heat wave, the heating element positioned relative to the seed container for directing the heat wave at the unprimed seeds within the seed container; and
the at least one type of energy wave includes the heat wave emitted by the heating element.

5. The seed-planting implement of claim 2, wherein:
the seed priming unit includes a light source configured to emit a light wave, the light source positioned relative to the seed container for directing the light wave at the unprimed seeds within the seed container; and
the at least one type of energy wave includes the light wave emitted by the light source.

6. The seed-planting implement of claim 5, wherein:
the light source is configured as a light-emitting diode.

7. The seed-planting implement of claim 2, the seed priming assembly further comprising:
a seed mover configured to convey the unprimed seeds through the seed container from the inlet to the outlet so that the unprimed seeds are primed by the seed priming unit.

8. The seed-planting implement of claim 7, the seed priming unit comprising:
a base; and
a plurality of light-emitting diodes configured to emit light waves, the plurality of light-emitting diodes circumferentially arranged on the base for directing the light waves at the unprimed seeds as the unprimed seeds are conveyed through the seed container by the seed mover.

9. The seed-planting implement of claim 7, wherein:
the seed mover is configured as a motorized rotatable auger extending from the inlet to the outlet of the seed container; and
rotation of the motorized rotatable auger moves the unprimed seed along the seed container from the inlet to the outlet.

10. The seed-planting implement of claim 9, wherein:
the motorized rotatable auger is rotated at a constant speed.

11. The seed-planting implement of claim 1, further comprising:
a computing system configured to control the operation of the metering component for adjusting a rate at which the unprimed seeds are metered to the seed priming assembly.

12. A system for controlling the operation of a seed-planting implement, the system comprising:
a row unit frame;
a plurality of ground-engaging tools supported by the row unit frame, the plurality of ground-engaging tools configured to engage the soil during a seed planting operation;
a seed reservoir supported by the row unit frame and configured to store seeds therein;
a metering component configured to meter untreated seeds;
a seed treatment assembly configured to receive and treat the untreated seeds metered by the metering component and convey treated seeds to the seed reservoir;
a fill level sensor configured to generate data indicative of a fill level of the seed reservoir; and
a computing system communicatively coupled to the fill level sensor, the computing system configured to:
determine the fill level of the seed reservoir based on the data generated by the fill level sensor; and
control an operation of the metering component based on the determined fill level of the seed reservoir.

13. The system of claim 12, wherein:
the metering component is rotatable at a rotational speed for metering the untreated seeds to the seed treatment assembly; and
when controlling the operation of the metering component, the computing system is configured to:
adjust the rotational speed of the metering component to adjust a rate at which the untreated seeds are metered to the seed treatment assembly.

14. The system of claim 12, wherein:
the metering component is rotatable at a rotational speed for metering the untreated seeds to the seed treatment assembly; and
the computing system is further configured to:
compare the determined fill level of the seed reservoir to a predetermined fill level threshold range; and
increase the rotational speed of the metering component to increase a rate at which the untreated seeds are metered to the seed treatment assembly when the determined fill level of the seed reservoir falls below the predetermined fill level threshold range.

15. The system of claim 12, wherein, when controlling the operation of the metering component, the computing system is configured to:
halt the operation of the metering component so that the metering component stops metering the untreated seeds to the seed treatment assembly.

16. The system of claim 12, wherein the computing system is further configured to:
compare the determined fill level of the seed reservoir to a predetermined fill level threshold range; and
halt the operation of the metering component so that the metering component stops metering the untreated seeds to the seed treatment assembly when the determined fill level of the seed reservoir falls within or exceeds the predetermined fill level threshold range.

17. The system of claim 12, wherein the seed treatment assembly is configured as a seed priming assembly configured to prime seeds for planting.

18. A system for controlling the operation of a seed-planting implement, the system comprising:
a row unit frame;
a plurality of ground-engaging tools supported by the row unit frame, the plurality of ground-engaging tools configured to engage the soil during a seed planting operation;
a metering component configured to meter untreated seeds;
a seed treatment assembly configured to receive and treat the untreated seeds metered by the metering component;
a seed rate sensor configured to generate data indicative of a rate at which the untreated seeds are metered to the seed treatment assembly; and
a computing system communicatively coupled to the seed rate sensor, the computing system configured to:
determine the rate at which the untreated seeds are metered to the seed treatment assembly based on the data generated by the seed rate sensor; and
control an operation of the metering component based on the determined rate at which the untreated seeds are metered to the seed treatment assembly.

19. The system of claim 18, wherein:
the metering component is rotatable at a rotational speed for metering the untreated seeds to the seed treatment assembly; and
when controlling the operation of the metering component, the computing system is configured to:
adjust the rotational speed of the metering component to adjust the rate at which the untreated seeds are metered to the seed treatment assembly.
